(19) United States
(12) Patent Application Publication
(10) Pub. No.: US 2005/0226220 A1
(43) Pub. Date: Oct. 13, 2005

(54) Analysing designs of services provided by means of a communication system

(75) Inventors: Kalevi Kilkki, Espoo (FI); Olli-Pekka Pohjola, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/900,383

(22) Filed: Jul. 28, 2004

(30) Foreign Application Priority Data
Apr. 5, 2004 (GB) 0407735.0

(51) Int. Cl. H04L 12/66

(52) U.S. Cl. 370/352

(57) ABSTRACT

A method for analyzing services offered via a communication system is disclosed. The method includes steps of analyzing demand for offered services and analyzing at least one quality aspect of at least one service on offer via a communication system. A net benefit analysis is then performed based upon the results of the analyzing steps. Implications of at least one design aspect of the offered services to aspects associated with merits of services offered via the communication system are then analyzed. An analyzer configured to analyze services offered via a communication system is also described.

### BACKGROUND OF THE INVENTION

1. Field of the Invention

The present invention relates to a communication system, and in particular to analysis and optimisation of the design of services offered by means of a communication system

2. Description of the Related Art

A communication system is typically configured to provide communications between two or more entities such as user equipment and/or other nodes associated with the communication system. The communication may comprise, for example, communication of voice, text, data, multimedia and so on. A user equipment connected to a communication system may, for example, be provided with a two-way telephone call or multi-way conference call. A user equipment may also communicate via the communication system with an application providing entity. The application providing entity may comprise, for example, a service provider. A service provider typically provides services by means of at least one application server (AS).

A vide variety of services may be offered by a service provider via a communications system. Non-limiting examples of service include voice communication services, data services, messaging services, multimedia services, Push-to-talk services, streaming services, game service and so on, and any combinations of these. Service providers also try to offer services that meet various demands of a diverse user base. Ever increasing number and variety of services is thus offered via communication networks. The services provided are also becoming increasingly complex by their design. This is especially the case with mobile communication services. New services and technologies with new requirements are emerging to terminals and networks.

The overall service design is considered as being of utmost importance for any service provider. A service provider has to make numerous decisions in relations to aspects such as the service products, pricing, marketing, Quality of Service (QoS) design, network resources, network target performance level, and so on. These decisions may affect the business of in various, complex ways that may be difficult to comprehend without the help of an analytical tool.

Decisions regarding an aspect of a service design may have a significant effect on interferences between different aspects. For example, the effect of pricing on the required capacity through demanded traffic may be a crucial issue for a service provider. However, it is difficult to assess these effects systematically. Moreover, the information regarding factors such as pricing, traffic and the cost of network capacity may be located in different parts of an organization providing service products, especially if the organization is substantially large. For example, pricing decisions may be made in one department of an organization, technical network planning in another department, and traffic monitoring in a third department. An illustrative example is a situation where a change in pricing structure from volume-based pricing to flat rate may have a momentous effect on offered traffic. However, in a specialized organization, the change in the traffic volumes may be noticed only afterwards, and the capacity upgrades may thus be planned too late. The consequences could be disastrous for service quality, unless there is provided a way of managing the whole process more systematically.

The relevant aspects of a service design may be strongly interdependent. Users may have limited amount of money and time to spend on using services. It may also be difficult to predict how the user are going to use their limited resources. Thus theoretical models may not work. A user may have to make choices which end-user services to use and how much to use them. These choices may depend on most aspects of a service design. The choices may particularly depend on particular needs of individual users, service features, pricing, quality of service and so on. A communication network may have capacity bottlenecks in links, nodes, application servers, or other elements. All services and users that use the bottleneck affect to the service quality experienced by a single user and vice versa. Advanced Quality of Service (QoS) designs can be used to differentiate products and users, i.e., to give more resources to some users or services at the expense of other users or services. In other words, providing services to users involves various variables which all affect service provider's business in various complex way that are difficult to comprehend.

A particular problem relates to analysis of implications of various aspects of service design to business measures, for example to revenue, cost, and user satisfaction. The service providers may try to address this problem by dividing service designs into several sub-areas, for example between marketing, pricing, traffic engineering and network planning. Specific analyzing tools may be used for analyzing each of these areas. There may also be specialists who use the specific tools to solve the specific problems of the specific sub-area. However, the limited area may also limit the design objectives, as an optimal design within a sub-area may not be optimal from the overall business perspective. Even if the objective is in the business issues, the limited scope forces to make assumptions in the other sub-areas like traffic demand and service quality. Thus any approach with separate design and optimisation may lead to serious difficulties.

### SUMMARY OF THE INVENTION

Embodiments of the present invention aim to address one or several of the above problems.

According to one embodiment, there is provided a method for analysing services offered via a communication system. The method comprises the steps of analysing demand for offered services and analysing at least one quality aspect of at least one service on offer via a communication system. A net benefit analysis is then performed based upon the results of the analysing steps. Implications of at least one design aspect of the offered services to aspects associated with merits of services offered via the communication system are then analysed.

According to another aspect of the present invention there is provided an analyser configured to analyse services offered via a communication system. The analyser comprises a demand analyser configured to analyse demand for offered services, and a quality analyser configured to analyse at least one quality aspect of at least one service on offer via a communication system. The analyser is provided with data processing facility configured to perform a net benefit analysis based upon information from demand analyser and quality analyser and to analyse implications of at least one design aspect of the offered service to aspect associated with merits of services offered via the communication system.

The embodiments of the invention may enable service providers to analyse their service design. A number of or even all offered end-user services may be analysed simultaneously.

### BRIEF DESCRIPTION OF DRAWINGS

For better understanding of the present invention, reference will now be made by way of example to the accompanying drawings in which:

FIG. 1 shows communication system;

FIG. 2 shows a model which may be used to analyse and optimise service provider's general service design;

FIG. 3 presents a structure for providing a service design analysis;

FIG. 4 presents possible functions in the steps of the analysis of FIG. 3;

FIG. 5 presents dimensions of the steps of the analysis of FIG. 3; and

FIG. 6 presents interdependences of the steps of FIG. 3.

### DETAILED DESCRIPTION OF THE PREFERRED EMBODIMENTS

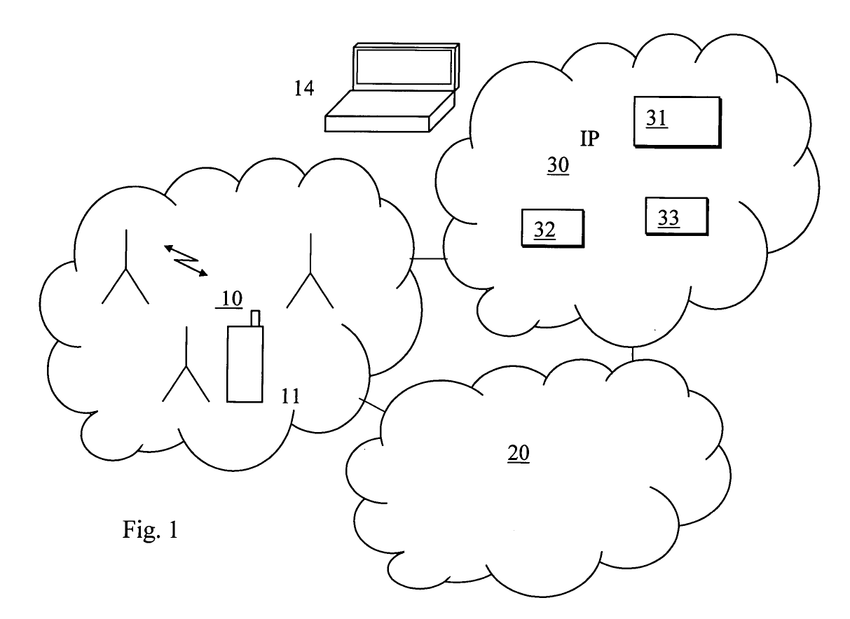

Reference is first made to FIG. 1 which shows a communication system comprising three different networks 10, 20 and 30. More particularly, the exemplifying communication system comprises a wireless network 10 proving wireless communication for a user equipment 11, a fixed line network 20 and a data network 30. The networks interface each other by appropriate arrangements. For example, one or more gateway nodes may be provided for connecting the communication networks to each other.

In a wireless system such as the network 10 communication occurs on a wireless interface between a user equipment 11 and the elements of the communication system. The wireless communication can be based on an appropriate communication protocol. Wireless systems are commonly referred to as mobile systems. An example of the mobile systems is the public land mobile network (PLMN). A PLMN is commonly based on cellular architecture. In a typical cellular architecture a base transceiver station (BTS) serves mobile stations (MS) or similar mobile user equipment (UE) 11 via an air or radio interface. A base station provides a radio access entity that is typically but not exclusively referred to as a cell. Another example is a mobile system that is based, at least partially, on use of communication satellites. Mobile communications may also be provided by means of other mobile systems, such as by means of wireless local area networks (WLAN).

From the other communication networks the data network 30 may be as an IP (Internet Protocol) and/or other packet switched data network 30. The fixed line network 20 may be any appropriate communication network providing fixed line communications for the users thereof.

Each communication network provides communication resources. For example communication resources include network resources such as base stations, links, nodes, and servers, their capacities and capabilities, and coverage in cellular network.

The mobile user equipment 11 of FIG. 1 may comprise any appropriate mobile user equipment adapted to connect the network 10. The user equipment is preferably adapted for Internet Protocol (IP) communication with entities locate in the data network 30. For example, the mobile user may access the cellular network by means of a Personal computer (PC), Personal Data Assistant (PDA), mobile station (MS) and so on. The following examples are described with reference to mobile stations.

The user equipment may connect, via the communication network 10, to various service provider entities 32, 33 and 34 providing service applications and connected to the data network 30. For example, the user may connect to servers that are generally connected to an external packet data network, for example to an Internet Protocol (IP) network. The data processing functions of the application servers may be provided by means of one or more data processor entities. Appropriately adapted computer program code product may be used for implementing the servers. It shall be appreciated that the user equipment 11 may communicate with application servers provided in different data networks.

A service product offered by a service provider may consists of a set of end-user services that have features like technical properties, availability, usability, content, expected quality, and QoS requirement. Information associated with QoS design of a service may comprise information regarding prioritization of users and/or services and/or applications, resource allocation, buffering structures and so on.

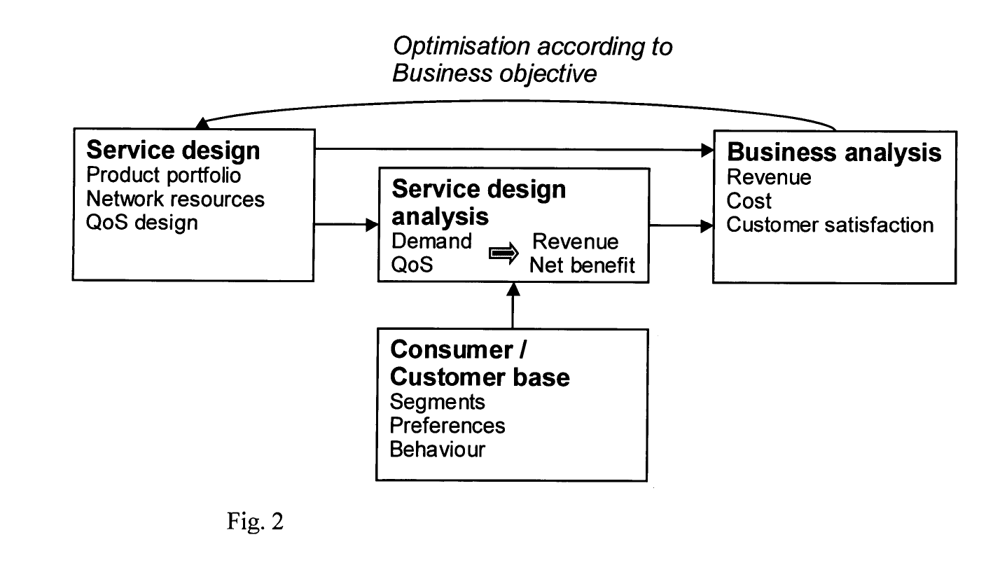

FIG. 2 show a block diagram for a high level service analysis and optimisation process for an expert system wherein the invention may be applied to. The expert system may be used by service providers to optimise their service designs, or by any other parties for analysing service products offered by service providers.

The expert system may be divided into functional blocks. FIG. 2 shows block for service design, for consumer base, service design analysis, and business analysis. Possible configurations of these functional blocks of an expert analyser system, their functions, inputs, and outputs are explained in more detail below.

The service design block 22 may define all relevant aspects of the service design. These aspects may include service portfolio, network resources, QoS design, and targeted performance level of a communication network or at least one element thereof. Product portfolio may include information regarding offered service products, their pricing, marketing, and so on. Products may be composed of end-user services. They may be defined by technical properties, availability, usability, content, expected quality, and QoS requirements. Network resources define the resources available for the services, network elements and their capabilities and capacities that affect the service quality, and service coverage. QoS design defines the QoS actions and mechanisms in the network. These are, e.g., prioritisation of packets and flows, buffering structures, and resource allocations. Target performance level defines target values for parameters defining network performance. Information associated with performance levels may comprise information regarding block rates, delays, drop rates, success rates, throughput, delivery times for different services and/application and/or users, and so on.

Consumer base block 24 is for defining the users or consumers of the services. Users may be divided into segments according to their needs, capabilities, resources, and behaviour. Needs generate demand for preferred services that are described by their technical properties, content, availability, usability, price, and quality. Benefits and costs from a preferred service may depend on these features and user capabilities and resources. Benefits and costs may be given as a function of usage demand. User behaviour is preferably defined as a function of technical properties, price, usability, availability, content, nature of the service market, service substitutes, time, region, and perceived quality.

A function of the service design analysis block 26 is to analyse the implications of at least one aspects of service design into aspects associated with merits of services offered via the communication system. Aspects associated with merits may include aspects such as revenues and net benefits of users, satisfaction of the users, or benefits to the society in general.

The service design may be analysed from user demand and network performance perspectives. In a demand perspective based approach a product portfolio is compared against user preferences, and where after demand for each service product is generated. In a network perspective based the generated traffic in the network is analysed where after network quality aspects are calculated for the end-user services. Common demand and quality level analysis may then information such as expected output operator's revenue and user's net benefit for the services, and service usage, which may then be fed back to traffic analysis.

Business analysis block 28 then functions to calculate revenue, cost, and user satisfaction for the analysed service design, and optimises the service design according to the business objective. Revenue is calculated in various dimensions from the results of service design analysis. Total cost includes costs due to service design, e.g. capital expenditure (CAPEX) costs due to network elements and operational expenditure (OPEX) costs due to dissatisfied customers. User satisfaction may depend on user needs and preferences and net benefits from offered services.

The expert system may be configured to assess the relevant aspects of a service design within one comprehensive model. The analysis of various aspects may be performed simultaneously and in one scale. The concept may be based on a holistic service design in which one or more objectives, for example a business objective, may justify all aspects of the service design such as pricing, QoS design, offered end-user services, network resources, and target performance level. The expert system may be configured to analyse implications of the service design to business measures, for example to revenue, costs, and user satisfaction. Measures may be used to optimise the service design according to a business objective.

The exemplifying embodiments described in more detail in the following relate to a part of the expert system that is configured to analyse implications of the service design to service revenues and net benefits of users. In this context the term ‘relevant’ is intended to mean those aspects of a service design which are interdependent and may have a significant effect on the business of a service provider, either directly or indirectly. For example, in mobile services a relevant aspect can be the product portfolio. This may include relevant products and services, their properties, pricing, and marketing. Another relevant aspect might be network resources. This may include relevant network elements, their capabilities and capacities. Yet another important aspect may be Quality of Service (QoS) design. This may include applied prioritisation, resource allocation, buffering structures, and so on.

Another relevant aspect might be the target performance level. This may include target values for parameters defining performance like block rates, delays, drop rates, success rates, throughputs, and delivery times.

An expert system may be configured to derive total revenue and user satisfaction measures. To provide these an analysis may be made regarding implications of various aspects of service design into revenue and total net benefit of the users. These aspects may include product portfolio, for example offered products, pricing, and marketing, network resources, QoS design in the network and so on.

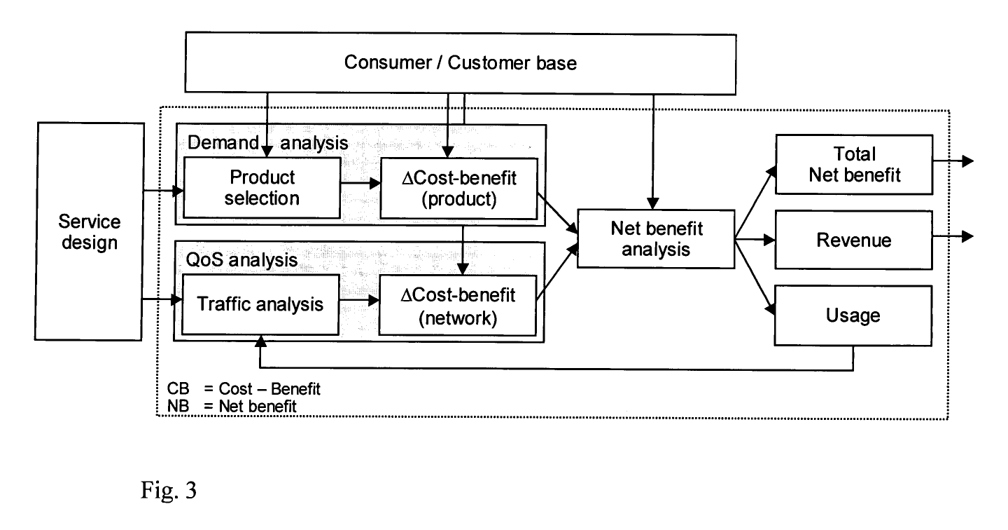

FIG. 3 shows an embodiment wherein a demand analysis, a QoS analysis, and a net benefit analysis are performed. In a demand analysis of block 40 different features of offered and preferred services are compared, and the demand for products and costs and benefits from the offered services for each user segment is computed.

QoS analysis is performed by block 44 for critical network elements. The critical elements may be configured to utilize the designed QoS mechanisms as defined by the particular service design. QoS analysis may include analysis of target performance levels. Results of the QoS analysis may be converted to costs and benefits according to user preferences and behaviour.

A net benefit analysis block 48 may be used to calculate parameters such as service usage 50, revenue 51, and user total net benefit 52 from the results of demand and QoS analysis 40, 44.

As shown, output information regarding service usage (see block 50) may be fed back to QoS analysis block 44, i.e. the method may be made iterative. Iteration may continue until a stable solution is reached. A stable solution is reached when a predefined stability criteria is satisfied. For example, a solution may be considered stable when differences between results of two or more consecutive iterations are small enough.

The analysis may be based on detailed consideration of user needs, capabilities, resources, and behaviour. User needs may create demand for imaginary preferred services that are able to satisfy those needs. Needs may be described in terms of usage, net benefit, costs, and/or benefits for the preferred services. Preferred services may be described in terms of technical properties, content, availability, usability, price, and quality.

Product portfolio, network resources, QoS design, and target performance level can be used to define the analysed service design. Product portfolio information may include data regarding aspects such as offered service products and included end-user services, marketing, and pricing. Information regarding network resources may include information regarding critical network elements, capacities, capabilities, and coverage in a cellular network. Target performance level may include data regarding aspect such as block rates, delays, drop rates, success rates, throughput, delivery times for different services and/or application and/or users.

Behaviour of a single user may be analysed when a specific end-user service is offered to him. Behaviour may be expressed in terms of service usage, total net benefit, costs, and/or benefits from, for example, service usage or availability. The net benefit may be, for example, a monetary value per month. The analysis may be based on a common microeconomic cost-benefit analysis. Such analysis may need to be modified such that it can be applied to the herein described expert system.

The usage analysis may be made separately for each service and user. Such analyses may, however, have interdependences due to user resources. Usage of a service may influence usage of another service. For example, this may occur if block pricing is applied and two service share a block. Similarly, there might be interdependencies due to time and money resources.

Offered services may have specific features which users experience when using the services. Features may be divided into various categories. For example, dynamical network dependent features such as bit rate, packet loss, delay, success rate, and availability may be classified as belonging to a category of network features while more static product dependent features like price, codec, content and usability are classified in another category. In an embodiment dynamical features are analysed by QoS analysis and static features are analysed by demand analysis.

Demand analysis of block 40 may be divided into a number of parts. For example, a demand analysis may be provided by a product selection analysis 41 and a cost-benefit analysis 42. Product selection analysis of sub-block 41 may include comparison of product portfolio against user preferences and formation of demand for the products based on the comparison. Cost-benefit analysis of sub-block 42 may compare various features of end-user services of the selected product with a preferred service, and calculate costs and benefits differences compared to the preferred service. Information regarding end-user services may comprise information regarding technical properties like screen size and coding, availability, usability, content, expected quality, expected price, and QoS requirements.

Information regarding services that can be analyzed may comprise various features of the service. For example, information regarding technical properties such as the screen size, a codec or sampling speed of a user equipment may be considered. The nature of content may be taken into account. Information regarding availability of services may be useful. For example, information regarding network coverage, server availability and/or signal blocking conditions may be utilized. Usability may be analyzed based on information regarding activation delays, learning times, set up time of the service, and/or user interface. Consideration regarding price may also be performed. These may be based on information regarding the rates, such as charging variables relating flat rates, block rates, time rates, volume rates, and transaction rates. Overall nature of the market may also have importance. This may be analyzed based on information regarding service penetration, marketing, and knowledge and awareness of the service offering. Quality aspects may be considered based on information regarding features such as bit rate, packet loss, jitter, delay, codec and so on.

QoS analysis of block 44 may also be divided into at least two parts. For example, a separate traffic analysis (block 45) and conversion of actual QoS parameters to costs and benefits (block 46) may be performed.

The traffic analysis of block 45 may first generate traffic based on the service design and the results from the usage analysis. The traffic analysis may then analyse the traffic in QoS critical network elements, for example in bottleneck links or nodes, and application servers. The result of the analysis may be combined with the target performance levels. The results of the combining may comprise parameters relating to technical service quality levels for each user and service.

These quality level parameters may then be converted in block 46 to relative or absolute costs and benefits as a function of usage demand for the net benefit analysis.

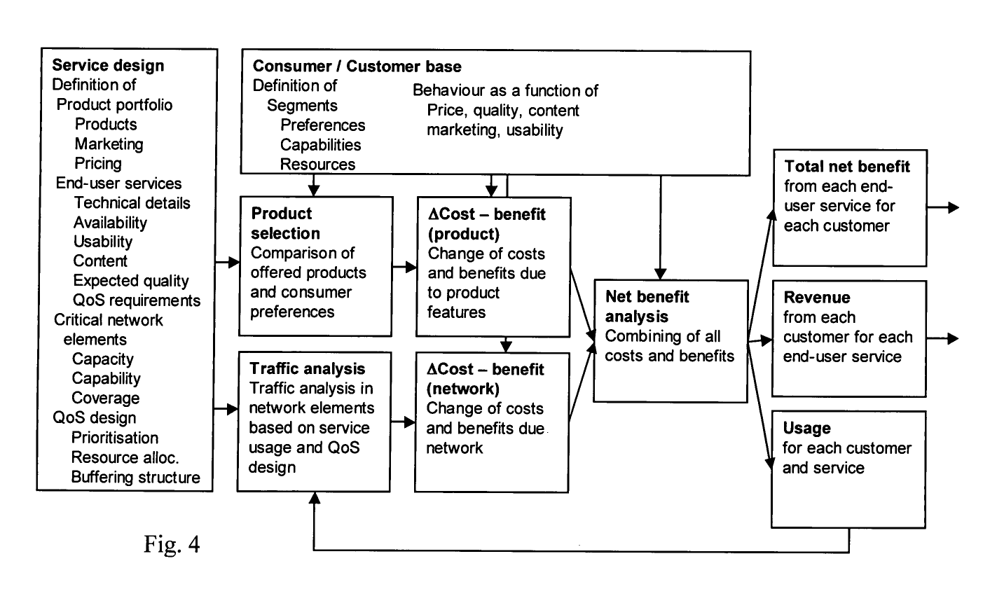

In accordance with an embodiment shown in FIG. 4 the analysis may comprise stages wherein a user base 24 is first formed based on different user preferences. User preference information may include information regarding technical properties, content, availability, usability and user interfaces, price, quality, usage demand, benefits, and costs. User capability information may also be stored, the user capability information concerning aspects such as terminal properties, e.g., screen size and available codecs, and personal skills.

User resource information may also be utilised. The user resource information may include information about the time and income the user has to spent on the services.

The user preferences may be compared with the products offered by a service provider. The result of the comparison is considered as an indication of the demand for each product in each user segment. Various features of the end-user service are then compared against user preferences. The results of the comparison may be in the form of absolute costs and benefits or costs and benefits relative to a preferred service.

QoS analysis is performed for critical network elements. The elements utilize the designed QoS mechanisms defined by the design of the service. During first iteration round, the usage of the end-user services is based on expected demand of the services. The expected demand may be based on prior knowledge of the quality of the offered service.

Results from the traffic analysis of block 45 are combined with target performance levels and the combination may then be analysed based on user preferences and behaviour. Results may be absolute or relative costs and benefits for each end-user service due to quality of service. Simultaneous net benefit analysis may be performed for all features of the end-user services. The results are service usage 50, operator revenue 51, and user's total net benefit for each service and user 52.

In the first iteration round, an ideal QoS may be assumed. Feedback is then given from service usage to traffic analysis. Iterations are continued until a stable solution is reached.

The following is an example how the analysis may proceed, what inputs might be used and what outputs might be provided, and what dimensions may be used in each step.

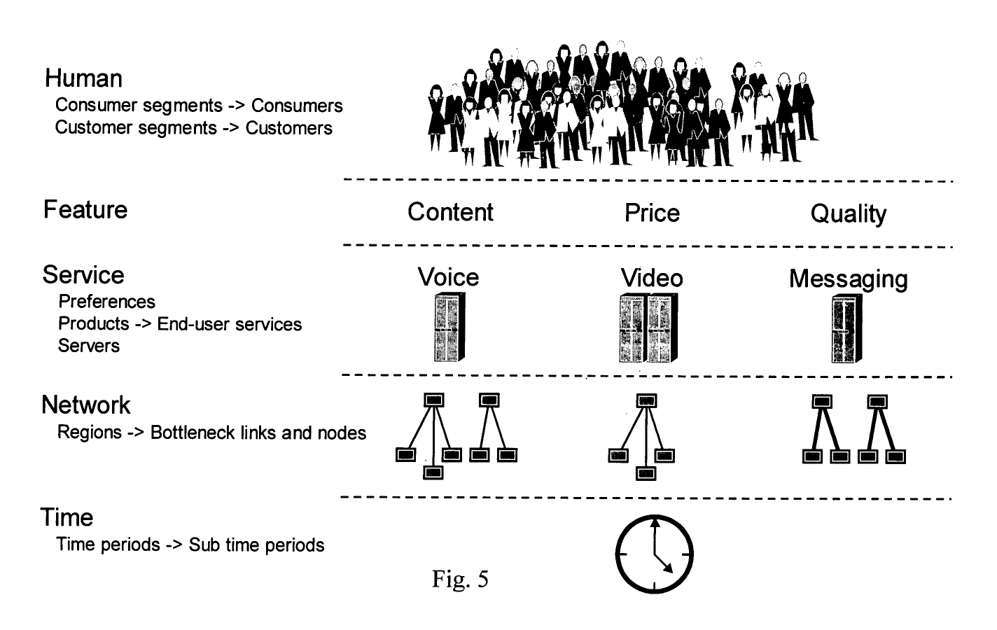

The analysis may proceed in several dimensions, see FIG. 5. Each dimension may have sub dimensions and segmentation.

The human dimension of the FIG. 5 model may include consumers in general and users. Consumers become users when they select to use a product. The basic segmentation is related to consumers. Additional segmentation may occur when the consumers in one segment selects different products.

The service feature dimension may include information about technical properties, content, usability, availability, price, nature of the service market, service substitutes, and quality.

The application dimension may include consumer preferences and offered products, which includes end-user services. Consumer preferences define the kind of applications the consumers might wish to use. End-user services define what applications are actually available. End-user service includes the effect of quality in the network side (quality of network service) through the application to the quality perceived by the user. The preferences and the realized services may not fully correspond.

Network dimension may include information regarding regions, e.g., hot spots, urban and suburban regions. Regions may include base stations, links and nodes. Various issues, usage, QoS design, target performance, and the availability of end-user services may depend on the region.

Time dimension may include information about time periods (for example, day, evening and night) and shorter sub periods for traffic analysis purposes. Various issues, like pricing, and usage may depend on the period.

The utilized dimensions and interdependences inside dimensions may vary in each stage of the analysis. In the analysis, product selection commonly occurs for each consumer/user, whereas services are usually considered interdependent. Traffic analysis may be done in each region and time period, which are divided into smaller units to get variation to the network. Analysis may include all users and end-user services. There may also be interdependences between network elements. Results may be converted to specific parameters concerning each user, end-user service, region, and time period. Costs and benefits can be calculated for each feature in each user, end-user service, region and time period. There may be no interdependencies. Net benefit analysis can be made for each user, service, region, and time period. Although interdependencies occur mainly between features, interdependencies may also exist between services, regions, and time periods.

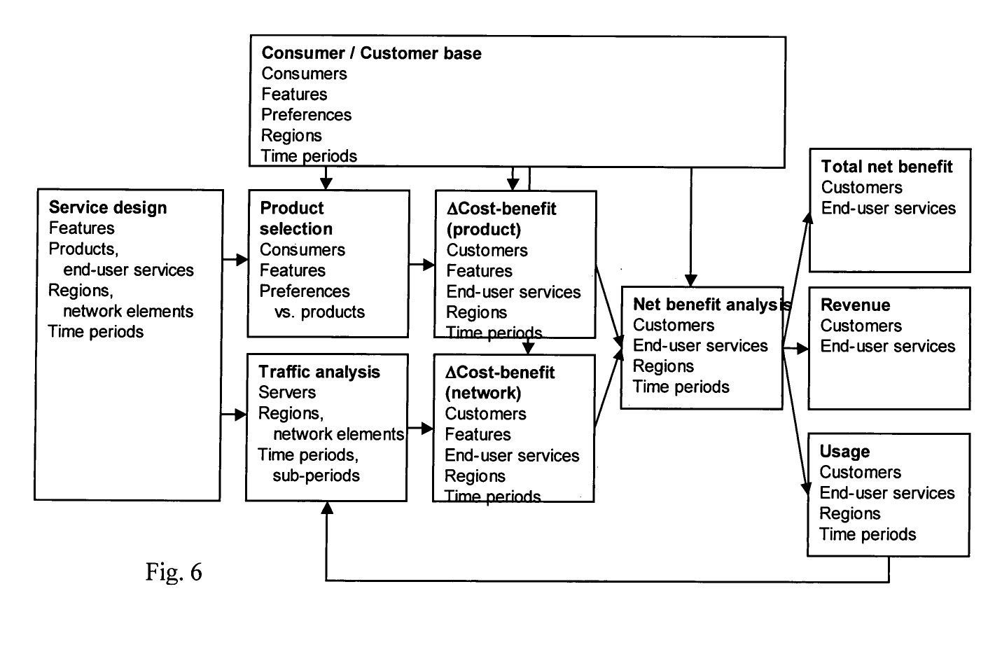

FIG. 6 illustrates the utilized dimensions in each discussed above step. Service usage may be calculated based on net benefit analysis for each user, service, region, and time period. The total net benefit and revenue for each user and service is obtained based on the individual net benefits.

The demand analysis compares the products with consumer's needs, creates demand for products, and calculates the costs and benefits compared to user preferences for each feature of service in each user, service, region, and time period. Analysis may include product related or expected features of the service design. Inputs for the analysis may include, for example:
From User base
   For each user (e.g. consumer) or user segment
      Resources
      Capabilities
      For each preferred service including time and region dependences
         Technical properties
         Content
         Availability
         Usability
         Price
         Nature of market
         Quality
         Benefits
         Costs
         Behaviour (e.g. service usage, net benefit, cost and/or benefit) as a function of
            Marketing
            Pricing
            Usability
            Content
            Expected quality
            Technical properties
            Quality
            Nature of market
            Time period
            Region
            Substitutes
From service design
   Expected network performance level
   For each product
   For each service including time and region dependences
      Technical properties
      Availability
      Usability
      Content
      Expected quality
      Pricing
      Marketing

Output from the demand analysis may be absolute or relative (compared to user preferences) costs and benefits as a function of usage demand for each feature of service for each user in each region and time period.

QoS analysis in the network may be based on features such as network resources, QoS design such as prioritisation, resource allocations, and buffering structures, target performance levels, QoS characteristics for end-user services, technical properties of end-user services, usage, user preferences and behaviour.

An objective of the QoS analysis is to give cost and benefits compared to reference (e.g. ideal) service for each service, user, region, and time period combination. Inputs for the QoS analysis may be, for example:
From service design
   For each network element
      Capacity
      Capability
      QoS design
   For each end-user service
      Technical details
      QoS characteristics
      Target network performance level
From service usage
   For each user
      For each end-user service
         For each region and time period
            Usage
From user base
   For each user
      For each end-user service
         Behaviour as a function of quality, availability, and usability

The QoS analysis may start with generation of traffic for each region and time period based on usages and technical details of end-user services. Generated traffic is divided to the critical network elements in accordance with distribution of traffic (time, element) in the network. The traffic can be treated in accordance with the QoS design and analysed in the designed buffering structures. Output from the analysis is the average service quality, availability, and usability level for each service and user in each region and time period. The technical service quality level is converted to absolute or relative (compared to some reference, e.g. ideal service) costs and benefits (positive or negative) as a function of service usage based on QoS requirements and user preferences and behaviour. Relative costs and benefits can also be relative to preference.

The net benefit may be determined by means of a usage analysis. The usage analysis may combine the results from the demand and QoS analyses. Inputs for the analysis may include, for example:
From the demand analysis
   For each region and time period
      For each user
      For each service
         For each feature
            Absolute or relative costs and benefits as a function of usage demand
From the QoS analysis
   For each region and time period
      For each user
      For each service
         For each feature
            Absolute or relative costs and benefits as a function of usage demand

Based on these inputs the model may estimate the service usage for each service and user in each region and time period, and calculates operator's revenue and user's total net benefit for each user and service.

A possible output from service design analysis may be of the form:
For each user
   For each service
      Total net benefit
      Revenue

The required data processing functions of the analysing system may be provided by means of one or more data processor entities. Appropriately adapted computer program code product may be used for implementing the embodiments, when loaded to a computer, for example for performing the computations and for retrieving and analysing information.

The data processing may be provided by means of an analyzing tool. In principle, the program code product may be run on any appropriate data processing facility, such as in a computer operated by a service provider, in a service provider server, or in a computer of an external analysing service provider. An external analyzing tool, such as the data processing device 14 of FIG. 1, may be used by service provider when designing and optimizing offered services and network. The analyzing tool may also be connected to a communication network to optimize some parameters thereof. The analyzing tool may also be useful for a user of services.

The program code product may be stored on and provided by means of a carrier medium such as a carrier disc, card or tape. A possibility is to download the program code product via a data network.

Information may be input in an analyser in various manners. It is possible to feed required data manually, for example by means of a keypad. An analyser may fetch at lest a part of the required information from an appropriate source, for example a service provider database. The analyser may be connected to a data network, and may be configured to retrieve at least a part of the required input information from a plurality of sources via the data network.

It should be appreciated that whilst embodiments of the present invention have been described in relation to user equipment such as mobile stations communicating via a mobile system, embodiments of the present invention are applicable to any other suitable type of user equipment and communication systems.

In the above certain embodiments of the present invention are described in the context of a communication system comprising at least one mobile network and a packet switched data network. This invention is also applicable to any other communication systems including local area networks, fixed line networks as well as any hybrids of any appropriate networks.

It is also noted herein that while the above describes exemplifying embodiments of the invention, there are several variations and modifications which may be made to the disclosed solution without departing from the scope of the present invention as defined in the appended claims.

1. A method for analyzing services offered via a communication system, the method comprising the steps of:
a) analyzing demand for offered services;
b) analyzing at least one quality aspect of at least one service on offer via a communication system;
c) performing a net benefit analysis based upon results of the analyzing steps a) and b); and
d) analyzing implications of at least one design aspect of the offered services to aspects associated with merits of the offered services.

2. The method as claimed in claim 1, further comprising:
performing at least one iteration, the iteration comprising inputting at least a part of an output from step c) as a feedback into step b) and repeating steps b) and c).

3. The method as claimed in claim 2, further comprising:
performing additional iterations until a predetermined degree of stability is obtained.

4. The method as claimed in claim 1, wherein step a) further comprises defining at least one preferred service for at least one group of users.

5. The method as claimed in claim 1, wherein step a) further comprises comparing features of an offered service and a preferred service.

6. The method as claimed in claim 5, further comprising:
comparing at least one of the features, wherein the features include at least one of technical properties, content, availability, usability, price, nature of a market for the services, marketing, quality, expected quality, time period, use area, and substitutes.

7. The method as claimed in claim 1, further comprising:
determining which of the offered services a user decides to use.

8. The method as claimed in claim 1, wherein step a) comprises computing usage demand for the offered services.

9. The method as claimed in claim 1, wherein step a) comprises computing at least one of net benefits and costs and benefits of the offered services.

10. The method as claimed in claim 1, wherein step b) comprises analyzing operation of at least one critical element of the communication system.

11. The method as claimed in claim 10, further comprising:
processing information regarding at least one of network resources, capacity, capability, and quality of service design of a critical element of the communication system.

12. The method as claimed in claim 10, further comprising:
analyzing operation of at least one of a link, a node, and a server.

13. The method as claimed in claim 1, further comprising:
defining at least one targeted performance level aspect for the at least one service.

14. The method as claimed in claim 13, further comprising:
defining a target performance level that associates with an aspect that comprises at least one of block rates, delays, drop rates, success rates, service throughputs, and service delivery times.

15. The method as claimed in claim 1, further comprising:
combining results of traffic analysis and information regarding a targeted performance level.

16. The method as claimed in claim 1, wherein step b) comprises analyzing traffic in the communication system and converting quality information associated with elements of the communication system to service quality aspects.

17. The method as claimed in claim 16, wherein a service quality aspect relates to at least one of a bit rate, a packet loss rate, a drop rate, call blocking, a delay rate, and a success rate.

18. The method as claimed in claim 1, further comprising:
converting results of step b) to costs and benefits based upon information regarding at least one user.

19. The method as claimed in claim 1, further comprising:
feeding back information regarding usage of the at least one service from step c) to step b).

20. The method as claimed in claim 1, wherein step d) comprises analyzing information from step c) regarding net benefits and revenue.

21. The method as claimed in claim 1, wherein step d) comprises analyzing implications of the at least one design aspect of the offered services to merits obtainable by at least one user of the offered services.

22. The method as claimed in claim 1, wherein step d) comprises analyzing implications of the at least one design aspect of the offered services to merits obtainable by a party paying for use of the offered services.

23. The method as claimed in claim 1, wherein step d) comprises analyzing implications of the at least one design aspect of the offered services to merits obtainable by at least one of at least one network operator and at least one service provider.

24. The method as claimed in claim 1, wherein step d) comprises analyzing implications of the at least one design aspect of the offered services to merits obtainable by society in general.

25. A computer program embodied on a computer-readable medium, said compute program for analyzing services offered via a communication system, the computer program executing a computer process comprising:
analyzing demand for offered services;
analyzing at least one quality aspect of at least one service on offer via a communication system;
performing a net benefit analysis based upon results of the analyzing the demand and analyzing the at least one quality aspect steps; and
analyzing implications of at least one design aspect of the offered services to aspects associated with merits of the offered services.

26. An analyzer configured to analyze services offered via a communication system, the analyzer comprising:
a demand analyzer configured to analyze demand for offered services;
a quality analyzer configured to analyze at least one quality aspect of at least one service on offer via a communication system;
a first processor configured to perform a net benefit analysis based upon information from the demand analyzer and the quality analyzer; and
a second processor configured to analyze implications of at least one design aspect of the services on offer to an aspect associated with merits of the offered services.

27. The analyzer as claimed in claim 26, wherein the at least one design aspect comprises at least one of a service portfolio, network resources, a quality of service design, and a targeted performance level of a network.

28. A communication system for analyzing services offered, the system comprising:
first analyzing means for analyzing demand for offered services;
second analyzing means for analyzing at least one quality aspect of at least one service on offer via a communication system;
performing means for performing a net benefit analysis based upon results of an analysis of the demand and an analysis of the at least one quality aspect; and
third analyzing means for analyzing implications of at least one design aspect of the offered services to aspects associated with merits of the offered services.
